(19) United States
(12) Patent Application Publication
(10) Pub. No.: US 2015/0273978 A1
(43) Pub. Date: Oct. 1, 2015

(54) METHOD FOR OPERATING A HEAT ACCUMULATOR OF A MOTOR VEHICLE

(71) Applicant: Robert Bosch GmbH, Stuttgart (DE)

(72) Inventors: Andreas WAGNER, Stuttgart (DE); Rainer SCHNURR, Stuttgart (DE); Juergen BIESTER, Boeblingen (DE); Michael GLORA, Markgroeningen (DE); Udo SCHULZ, Vaihingen/Enz (DE); Stefan Andreas KNIEP, Hildesheim (DE); Joerg HEYSE, Besigheim (DE); Judith HARL-MITTENDORFER, Wien (AT)

(21) Appl. No.: 14/674,497

(22) Filed: Mar. 31, 2015

(30) Foreign Application Priority Data
Mar. 31, 2014 (DE) 10 2014 205 920.8

(51) Int. Cl. B60H 1/00

(52) U.S. Cl. CPC B60H 1/00492

(57) ABSTRACT

A method is provided for operating a heat accumulator of a motor vehicle. Accordingly, following a start of the motor vehicle, a length and/or duration of a distance to be driven by the motor vehicle are/is ascertained or estimated. Depending on the length and/or the duration, a decision is made as to whether discharging of the heat accumulator will be carried out.

### FIELD OF THE INVENTION

The present invention relates to a method for operating a heat accumulator of a motor vehicle. In addition, the present invention relates to a computer program, which is designed to execute each step of the method of the present invention, and it relates to a machine-readable storage medium, on which the computer program according to the present invention is stored. Finally, the present invention pertains to an electronic control unit, which is set up to operate a heat accumulator of a motor vehicle using the method of the present invention.

### BACKGROUND INFORMATION

Heat accumulators in motor vehicles are used for optimizing the vehicle's warm-up phase. After the combustion engine of the motor vehicles has been started up, the heat accumulators allow rapid heating of fluid media such as cooling water, engine oil and transmission oil. This makes it possible to minimize the carbon dioxide emissions and to increase the comfort of the vehicle occupants by rapidly providing heat. It is also known to use heat accumulators to quickly heat the exhaust manifold of a motor vehicle in an effort to reduce the harmful emissions.

In general, a heat accumulator is evacuated at the start of a trip, i.e., the stored heat is released by the accumulator. Heat is stored again at the end of the trip, which means that the heat accumulator is replenished again. However, this works only if the driving route is long enough, so that a sufficient quantity of heat and a sufficiently high temperature are available for the accumulator. This is not the case for short driving distances.

In such a case, the accumulator may indeed already have absorbed a certain quantity of thermal energy, but for chemical reasons it cannot be stored permanently and is therefore released to the environment again during the standstill phase that follows the driving. To allow permanent storing of the thermal energy for an unlimited time, i.e., depending on the type of accumulator, at ambient temperatures above −10° C., the accumulator must be filled completely, which means that the accumulator has to be supplied with a sufficiently large heat flow over a sufficiently long period of time.

Apart from the disadvantage that a depleted heat accumulator is unable to be fully replenished when driving short distances, the advantage achieved by the accumulator can possibly be used for only a very brief period of time on the short trip. This means that the thermal energy is put to poor use.

### SUMMARY

The method for operating a heat accumulator of a motor vehicle according to the present invention includes the ascertaining or estimating of a length and/or duration of a distance to be traveled by the vehicle after the motor vehicle has been started up. Depending on the length and/or duration, a decision is made whether the heat accumulator is to be evacuated. This ensures that the accumulator will not be used when traveling short distances.

The ascertaining or estimating of the length and/or duration of the distance to be traveled by the motor vehicle in particular is made on the basis of information available in a navigation device of the motor vehicle. This information is provided either by a destination input by the driver or by stored information about the usual driving behavior of the driver. Route data can be supplied by an electronic horizon, in particular. An electronic horizon is a compilation of data by which topological and geographical conditions in the environment of the vehicle, among other things, are represented. The electronic horizon is generated from the data of a digital navigation map. A so-called horizon provider, which, for example, may be the navigation device, sends the data to other control units via a vehicle bus, such as a CAN, for instance, using a defined protocol. A protocol that is usable in the present invention for transmitting the electronic horizon in particular is ADASIS (Advanced Driver Assistant System Interface Specification). The horizon provider supplies other control units of the motor vehicle with a small cutaway portion of the digital navigation map in a simple format. It ascertains the route which the driver will most likely select. This route is referred to as the Most Probable Path (MPP). If the driver has input a destination into the navigation device, the particular route may be used as MPP. If this is not the case, the MPP can be determined on the basis of simple heuristics. For example, it is assumed that primary roads are given preference. Using statistics, it may also be ascertained via routes that the driver has chosen in the past. The horizon provider supplies attributes along the MPP. Such attributes, for instance, may be the anticipated speed, the gradient or curvature characteristic of the road along the MPP, or information about intersections along the MPP.

In one preferred specific embodiment of the method of the present invention, the heat accumulator is discharged only if the length and/or the duration most likely are/is sufficient to completely replenish the heat accumulator again while the motor vehicle is being driven. This avoids a discharge of the heat accumulator while the motor vehicle is in a standstill phase.

The temporal characteristic of a heat flow generated by a combustion engine of the motor vehicle is especially preferably estimated; furthermore, taking the ambient temperature of the motor vehicle into account, it is estimated which portion of this heat flow is able to be supplied to the heat accumulator while the motor vehicle is being driven. To do so, first in particular the anticipated drive load over the distance of the motor vehicle that will most likely be driven is estimated. In one specific embodiment of the method of the present invention, this may be done with the aid of statistics, which include the average drive load of past trips for already driven routes. These statistics are continuously updated, in particular. As an alternative, in one specific embodiment of the method of the present invention, the drive load may also be estimated on the basis of the resistance-to-motion equation. To do so, the appropriate vehicle parameters are ascertained in advance and stored in a database inside the vehicle. The route parameters, such as the gradient of the travel route and the anticipated speed along the travel route, for instance, are gathered from the electronic horizon. The temporal characteristic of the heat flow generated by the combustion engine is estimated in particular on the basis of a model of the load-dependent heat development of the combustion engine. The estimate of the portion of the heat flow that is able to be supplied to the heat accumulator while the motor vehicle is driven is made with the aid of a further model, in particular. For the decision as to whether the heat accumulator is to be emptied, the heat flow characteristic that will most likely be generated is especially preferably compared to the heat flow characteristic required for the regeneration of the heat accumulator, a constant offset being deducted from the most likely generated heat flow characteristic prior to the comparison. This compensates for a possible overestimation. In situations in which the required and the most likely generated heat flows are close to each other, the heat accumulator will therefore not be emptied, to be on the safe side.

In this specific embodiment of the method of the present invention, it is furthermore especially preferred that the length and/or duration the motor vehicle must be driven on average until the heat accumulator is fully charged is ascertained with the aid of statistics.

This value and the length and/or duration of the predicted travel distance are/is used for the decision whether the heat accumulator will be evacuated at the start of a trip.

In a still other preferred specific embodiment of the method according to the present invention, a probability that the heat accumulator will be completely filled again across a predicted travel route of the motor vehicle is ascertained, and the heat accumulator is evacuated only if this probability lies above a probability threshold value. The probability is preferably recalculated on a continuous basis. This is useful especially in situations in which the expected travel route cannot yet be predicted with sufficient precision at the start of the trip. By considering the distance that was traveled during the current drive, a possibly not precise enough prediction of the travel duration may be possible at a later point in time.

In this specific embodiment of the method of the present invention, it is especially preferred that the evacuation of the heat accumulator does not take place if a temperature of the combustion engine exceeds a temperature threshold value. In this way an evacuation of the heat accumulator occurs only if the temperature of the internal combustion engine is still so low that the evacuation of the heat accumulator makes sense.

In all specific embodiments of the method of the present invention it is preferred that after each evacuation of the heat accumulator, it is recorded in a database of the motor vehicle whether the length and/or duration of the route subsequently traveled by the motor vehicle was/were sufficient to completely refill the heat accumulator again. The information recorded in the database is subsequently taken into account in the decision whether the heat accumulator is to be evacuated. In this way it is prevented that the heat accumulator will always be discharged on a certain route that the motor vehicle travels on a regular basis, such as a ride to the workplace of the vehicle owner, and that it can subsequently be fully refilled again.

It is furthermore preferred that the instant at which the heat accumulator will be refilled is selected as a function of a length and/or duration of a route to be traveled by the motor vehicle. In this way the prediction of the travel route that is required to execute the method of the present invention is also utilized for refilling the heat accumulator. If it is known that the refilling of the heat accumulator will take a certain amount of time, then the refilling in particular may start precisely around this time period, prior to the end of the trip.

The computer program according to the present invention is designed to execute all steps of the method according to the present invention. It allows the implementation of the method of the present invention on a computer device or control unit without requiring structural modifications of these devices. For this purpose the computer program of the present invention is stored on the machine-readable storage medium according to the invention. The electronic control unit according to the present invention is obtained by importing the computer program of the present invention into an electronic control unit. It is set up to operate a heat accumulator of a motor vehicle with the aid of the method of the present invention.

### BRIEF DESCRIPTION OF THE DRAWINGS

FIG. 1 shows the temporal characteristic of a medium temperature and a storage temperature in a motor vehicle during a long trip.

FIG. 2 shows the temporal characteristic of a medium temperature and a storage temperature in a motor vehicle during a short trip.

FIG. 3 shows a flow chart of a method according to an exemplary embodiment of the present invention.

FIG. 4 shows a flow chart of a method according to another exemplary embodiment of the present invention.

### DETAILED DESCRIPTION

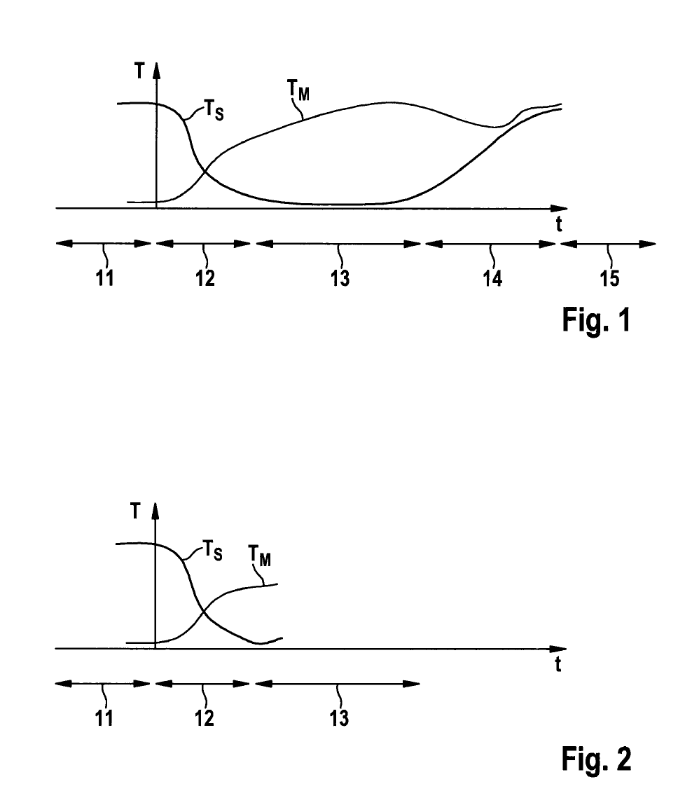

In a cold start, a motor vehicle equipped with a fully charged heat accumulator is in a state in which media temperature T_{M} of its fluid media, such as cooling water, transmission oil, engine oil etc. is at a low value, while storage temperature T_{S} of its heat accumulator is at a very high value. If the motor vehicle is started up, these temperatures T_{M}, T_{S} change over time t, as illustrated in FIG. 1. The heat accumulator is fully charged in a first time period 11. In a second time period 12, which begins right after the internal combustion engine of the motor vehicle has been started up, the heat accumulator is discharged. This causes a considerable rise in media temperature T_{M}, whereas storage temperature T_{S} drops to its minimum value. A further rise in media temperature T_{M} occurs in third time period 13, due to the operation of the internal combustion engine, while the temperature of the discharged heat accumulator remains unchanged. If media temperature T_{M} has reached a sufficiently high value, the heat accumulator will be charged again in a fourth time period 14, which leads to a renewed increase in storage temperature T_{S} to its initial value. In the process, media temperature T_{M} drops temporarily and rises again toward the end of heat accumulator charging. In a fifth time period 15, the heat accumulator is fully charged and available for the renewed discharging in a new engine start.

If the motor vehicle is driven for only a short distance, the characteristic of temperatures T_{M}, T_{S} illustrated in FIG. 2 results. In this case as well, at first the heat accumulator is fully charged in a first time period 11, and media temperature T_{M} is at its minimum value. Because of the discharging of the heat accumulator in second time period 12, storage temperature T_{S} drops to its minimum while media temperature T_{M} rises. However, the shutoff of the internal combustion engine already takes place in third time period 13. Media temperature T_{M} therefore remains essentially at the value it had assumed as a result of the discharging of the heat accumulator, so that no new charging of the heat accumulator takes place. In the next drive cycle of the motor vehicle, the heat accumulator thus is not available for increasing media temperature T_{M}. This is avoided in the exemplary embodiments of the method of the present invention described in the following text.

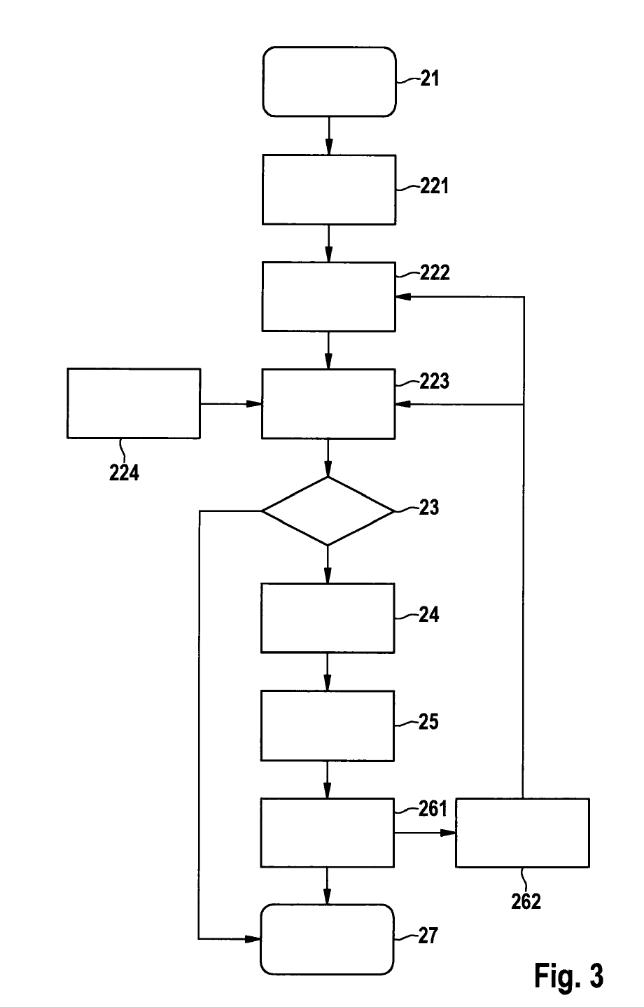

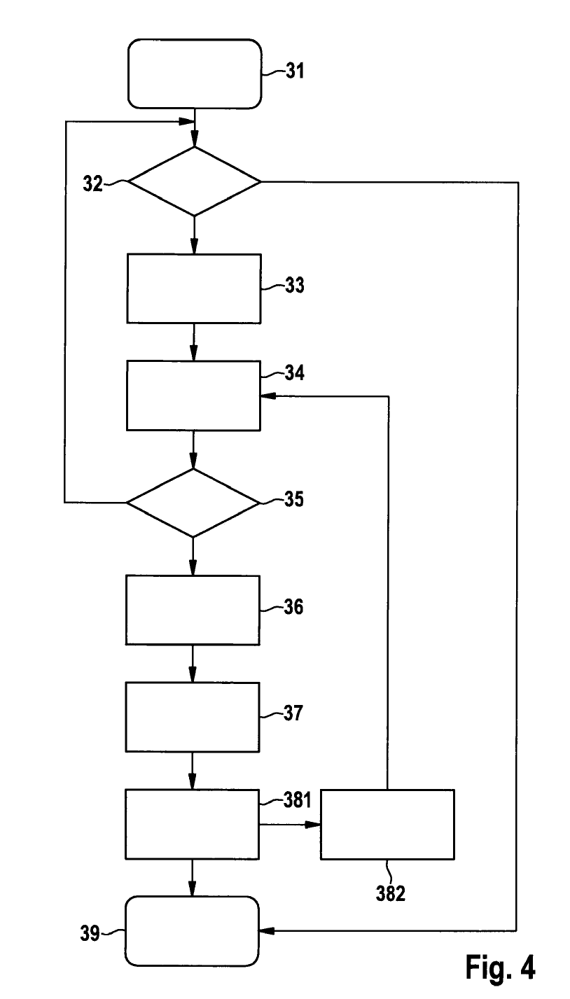

A first exemplary embodiment of the method of the present invention, which is schematically illustrated in FIG. 3, is initiated by start 21 of a combustion engine of a motor vehicle equipped with a heat accumulator. Based on data from a navigation device of the motor vehicle, the length of the route to be traveled by the motor vehicle is ascertained, and the driving duration is estimated 221. This data is used for estimating the expected drive load across the route; route parameters such as the gradient of the route and the anticipated speed along the route are gathered from an electronic horizon, as it is known from EP 1 775,552 A2, for instance. Using a model of the load-dependent heat development of the combustion engine and utilizing the predicted load profile, an estimate 222 of the heat flow generated by the combustion engine is prepared. This is followed by an estimate 223 of the particular portion of this heat flow that is able to be supplied to the heat accumulator during the vehicle travel. Another model, which considers ambient temperature 224 of the motor vehicle, is used for this purpose. The heat flow characteristic that is expected to be generated is compared with the heat flow characteristic required for the full charging of the heat accumulator. If the length and duration of the motor vehicle trip are insufficient for generating a heat flow characteristic that enables complete refilling of the heat accumulator, then the method of the present invention is terminated without discharging the heat accumulator. In the other case, discharging 24 of the heat accumulator takes place. Renewed filling 25 of the heat accumulator takes place at an instant that is ascertained using the data of the travel route and the duration ascertained in step 221. If the filling of the accumulator takes two minutes, for instance, then the recharging starts two minutes prior to the end of the trip.

At the end of the trip of the motor vehicle, information 262 as to whether the heat accumulator was actually able to be fully recharged over the past travel distance and duration is recorded 261. This information 262 will be taken into account in future estimates 222 of the generated heat flow and estimates 223 of the heat flow supplied to the heat accumulator. The method of the present invention ends 27 after this information 262 has been recorded 261.

A second exemplary embodiment of the method of the present invention, whose sequence is schematically shown in FIG. 4, likewise begins with start 31 of the combustion engine of a motor vehicle. A comparison 32 of the engine temperature with a temperature threshold value takes place. If this temperature threshold has already been exceeded, then discharging of a heat accumulator of the motor vehicle would not be useful and the method of the present invention is terminated immediately. In the other case, a prediction 33 of the destination most likely selected by the driver of the vehicle and the corresponding travel route takes place on the basis of past trips.

Methods such as those known from US 2008/0027639 A1, U.S. Pat. No. 8,229,666 B2 and U.S. Pat. No. 7,418,342 B1, for instance, are used for this purpose. Based on the travel route ascertained in this manner, the probability that the heat accumulator will be fully recharged again over the predicted travel distance is determined 34. This is followed by a comparison 35 of this probability with a probability threshold value. If the probability threshold value is not attained, then a return to step 32 of the method takes place and a renewed check is performed whether the engine temperature has since exceeded the temperature threshold value. In the other case, i.e., if the probability of successful recharging of the heat accumulator is high enough, discharging 36 of the heat accumulator takes place. Subsequent replenishing 37 of the heat accumulator is carried out in a timely manner before the end of travel of the vehicle, based on the route data predicted in step 33. After the trip has ended, information 382 as to whether complete replenishing of the heat accumulator has actually been successful over this driven distance and travel duration is recorded 381. This information 382 is taken into account in future probability calculations 34. Once the recording 381 has been concluded, the method according to the present invention is ended 39.

The method of the present invention according to its two previously described exemplary embodiments is used in an especially advantageous manner in exploitation scenarios in which a motor vehicle covers short and long distances in alternation. Without the method of the present invention, the heat accumulator is evacuated at the start of the short route. This results in only negligible fuel savings, because the motor vehicle drives only a short distance at a consumption that is reduced in comparison with a cold engine. Since the segment is short, the accumulator cannot be fully regenerated during the trip. In the least favorable case, the heat accumulator therefore loses its entire thermal energy in the subsequent stationary phase of the motor vehicle. The heat accumulator will then not be available for the following longer drive. The consumption of the vehicle then corresponds to the consumption of a motor vehicle without heat accumulator. However, during the longer trip the heat accumulator can be fully charged and thus is available again during the next trip. The heat accumulator is discharged at the start of the trip. If the next trip once again involves a short distance, the fuel savings are low, as described above. In other words, without the method of the present invention, the heat accumulator thus does not offer any real fuel advantages at continual changes between short and long distances, in comparison with a motor vehicle without heat accumulator. The same applies to a use scenario in which each long distance trip is followed by several short distance trips one after the other at certain time intervals. When using the method of the present invention, on the other hand, the accumulator will not be discharged when driving short distances. It is therefore available for each long distance trip and provides a corresponding fuel advantage there.

What is claimed is:

1. A method for operating a heat accumulator of a motor vehicle, comprising:
after a start of the motor vehicle, one of ascertaining or estimating at least one of a length and a duration of a route to be traveled by the motor vehicle; and
making a decision as a function of the at least one of the length and the duration as to whether a discharging of the heat accumulator will take place.

2. The method as recited in claim 1, wherein the discharging of the heat accumulator is performed only if the at least one of the length and the duration is sufficient to completely replenish the heat accumulator again in the course of the travel of the motor vehicle.

3. The method as recited in claim 2, further comprising:
estimating a temporal characteristic of a heat flow generated by a combustion engine of the motor vehicle; and
taking an ambient temperature of the motor vehicle into account, estimating which portion of the heat flow is able to be supplied to the heat accumulator while the motor vehicle is being driven.

4. The method as recited in claim 1, further comprising ascertaining a probability that the heat accumulator will be completely replenished again across a predicted travel route of the motor vehicle, wherein the discharging of the heat accumulator takes place only if the probability lies above a probability threshold value.

5. The method as recited in claim 4, wherein the discharging of the heat accumulator does not take place if a temperature of a combustion engine exceeds a temperature threshold value.

6. The method as recited in claim 1, further comprising:
after each discharging of the heat accumulator, recording information in a database of the motor vehicle as to whether the at least one of the length and the duration of the route subsequently driven by the motor vehicle was sufficient to completely recharge the heat accumulator again; and
taking into account the recorded information in the decision whether the discharging of the heat accumulator will take place.

7. The method as recited in claim 1, further comprising selecting an instant of a recharging of the heat accumulator as a function of at least one of a length and a duration of a distance to be driven by the motor vehicle.

8. A computer program, which is set up to execute a method for operating a heat accumulator of a motor vehicle, comprising:
after a start of the motor vehicle, one of ascertaining or estimating at least one of a length and a duration of a route to be traveled by the motor vehicle; and
making a decision as a function of the at least one of the length and the duration as to whether a discharging of the heat accumulator will take place.

9. A machine-readable storage medium, on which a computer program is stored for executing a method for operating a heat accumulator of a motor vehicle, comprising:
after a start of the motor vehicle, one of ascertaining or estimating at least one of a length and a duration of a route to be traveled by the motor vehicle; and
making a decision as a function of the at least one of the length and the duration as to whether a discharging of the heat accumulator will take place.

10. An electronic control unit, which is set up to operate a heat accumulator of a motor vehicle using a method for operating a heat accumulator of a motor vehicle, comprising:
after a start of the motor vehicle, one of ascertaining or estimating at least one of a length and a duration of a route to be traveled by the motor vehicle; and
making a decision as a function of the at least one of the length and the duration as to whether a discharging of the heat accumulator will take place.
